(19) United States
(12) Patent Application Publication
(10) Pub. No.: US 2020/0305671 A1
(43) Pub. Date: Oct. 1, 2020

(54) SURFACE CLEANING APPARATUS

(71) Applicant: Omachron Intellectual Property Inc., Hampton (CA)

(72) Inventor: Wayne Ernest Conrad, Hampton (CA)

(21) Appl. No.: 16/368,153

(22) Filed: Mar. 28, 2019

(51) Int. Cl. A47L 9/28; H01M 10/613; H01M 10/623; H01M 10/66

(52) U.S. Cl. CPC A47L 9/2884; H01M 10/613; H01G 11/18; H01M 10/66; H01M 2220/30; H01M 10/623

(57) ABSTRACT

A surface cleaning apparatus having an on board energy storage member and an air flow passage from a dirty air inlet to a clean air outlet with an air treatment member and a suction motor provided in the air flow path. The on board energy storage member operably connected to the suction motor and in thermal communication with the air flow path at a location upstream of the suction motor.

### FIELD

The described embodiments relate to surface cleaning apparatus, particularly surface cleaning apparatus having on board energy storage.

### INTRODUCTION

Various types of surface cleaning apparatus are known, including upright surface cleaning apparatus, canister surface cleaning apparatus, stick surface cleaning apparatus, hand carriable surface cleaning apparatus, and central vacuum systems.

While some surface cleaning apparatus are powered by external sources, others are powered by on board energy storage members. Many on board energy storage members produce heat when discharging, particularly when discharging at a high rate such as when a user increases the power consumption of a power consuming member.

### SUMMARY

The following introduction is provided to introduce the reader to the more detailed discussion to follow. The introduction is not intended to limit or define any claimed or as yet unclaimed invention. One or more inventions may reside in any combination or sub-combination of the elements or process steps disclosed in any part of this document including its claims and figures.

In accordance with a first aspect, a surface cleaning apparatus has on board energy storage. The on board energy storage may be provided by one or more energy storage members such as a battery or a capacitor (e.g., a super capacitor). The energy storage member(s) may be provided in a housing (e.g., a battery pack) which may be removably mounted to the surface cleaning apparatus. Typically, during operation, a suction motor produces heat that may need to be dissipated. Accordingly, the air travelling through a surface cleaning apparatus may be used to cool a suction motor. However, while the air downstream of a suction motor may have been treated to remove particulate matter and may therefore be useable to cool a battery pack without contaminating the battery pack with dirt, the air has been heated by the suction motor and therefore its efficacy to cool a battery pack is at least limited. In accordance with this aspect, the energy storage member(s) are in thermal communication with the air flow passage through the surface cleaning apparatus at a location upstream of the suction motor. The energy storage members may, e.g., abut or form part of the air flow path and thereby be cooled by the flow of air through the surface cleaning apparatus upstream of the suction motor without becoming contaminated by dirt entrained in the air flow stream.

In accordance with this aspect, there is provided a surface cleaning apparatus having an on board energy storage member, the surface cleaning apparatus comprising:
a) an air flow passage from a dirty air inlet to a clean air outlet with an air treatment member and a suction motor provided in the air flow path; and,
b) at least one energy storage member operably connected to the suction motor, wherein the at least one energy storage member, or an energy storage member pack containing the at least one energy storage member, is in thermal conductive communication with the air flow passage.

In some embodiments, the at least one energy storage member, or the energy storage member pack containing the at least one energy storage member, may abut a portion of the air flow passage.

In some embodiments, the at least one energy storage member, or the energy storage member pack containing the at least one energy storage member, may be in thermal conductive communication with the air treatment member.

In some embodiments, the air treatment member with which the at least one energy storage member, or the energy storage member pack containing the at least one energy storage member, is in thermal conductive communication may be a cyclone.

In some embodiments, the air treatment member with which the at least one energy storage member, or the energy storage member pack containing the at least one energy storage member, is in thermal conductive communication may be a pre-motor filter chamber.

In some embodiments, the at least one energy storage member, or the energy storage member pack containing the at least one energy storage member, may be in thermal conductive communication with an above floor cleaning wand.

In some embodiments, the at least one energy storage member may comprise a plurality of batteries that are arranged around an open interior volume and a portion of the air flow passage may extend through the open interior.

In some embodiments, the surface cleaning apparatus may further comprise a surface cleaning head and an upper section moveably mounted to the surface cleaning head between a storage position and a reclined in use position, the upper section comprising an up flow duct, wherein the at least one energy storage member, or the energy storage member pack containing the at least one energy storage member, may be in thermal conductive communication with the up flow duct.

In some embodiments, the plurality of batteries may be arranged in an annular configuration that seats around a portion of the air flow passage.

In some embodiments, the surface cleaning apparatus may comprise a hand vacuum cleaner having an inlet passage and the at least one energy storage member, or the energy storage member pack containing the at least one energy storage member, may be in thermal conductive communication with the inlet passage.

In accordance with a second aspect, the on board energy storage members may be cooled using a heat pipe. The heat absorption portion of the heat pipe path may be in thermal communication with the on board energy storage member(s) and the heat dissipation portion of the heat pipe path may be in thermal communication with the air flow path at any suitable location upstream of the suction motor, e.g., it may abut or form part of the air flow path.

In accordance with this aspect, there is provided a surface cleaning apparatus having an on board energy storage member, the surface cleaning apparatus comprising:
a) an air flow passage from a dirty air inlet to a clean air outlet with an air treatment member and a suction motor provided in the air flow path;
b) at least one energy storage member operably connected to the suction motor; and,
c) a heat pipe thermally connecting the at least one energy storage member, or an energy storage member pack containing the at least one energy storage member, with the air flow passage.

In some embodiments, the heat pipe may be in thermal conductive communication with the air treatment member.

In some embodiments, the air treatment member with which the heat pipe is in thermal conductive communication may be a cyclone.

In some embodiments, the air treatment member with which the heat pipe is in thermal conductive communication may be a pre-motor filter chamber.

In some embodiments, the heat pipe may be in thermal conductive communication with an above floor cleaning wand.

In some embodiments, the surface cleaning apparatus may comprise a hand vacuum cleaner having an inlet passage and the heat pipe is in thermal conductive communication with the inlet passage.

### BRIEF DESCRIPTION OF THE DRAWING

For a better understanding of the described embodiments and to show more clearly how they may be carried into effect, reference will now be made, by way of example, to the accompanying drawings in which:

FIG. 1A is a top perspective view of an energy storage device;

FIG. 1B is a top perspective view of an alternate energy storage device;

FIG. 1C is a top perspective view of a further alternate energy storage device;

FIG. 1D is a top perspective view of a further alternate energy storage device;

FIG. 1E is a top perspective view of an energy storage device pack arranged around a duct;

FIG. 2A is a front perspective view of a surface cleaning apparatus, according to an embodiment;

FIG. 2B is a cross sectional view of the surface cleaning apparatus of FIG. 2A taken along line 2B-2B;

FIG. 3A is a schematic view of an alternate surface cleaning apparatus, with an on board energy storage member pack abutting a fluid inlet;

FIG. 3B is a front perspective view of an alternate surface cleaning apparatus, with an on board energy storage member pack abutting a fluid inlet;

FIG. 3C is a schematic view of the surface cleaning apparatus of FIG. 3A, with the on board energy storage member pack abutting a separation chamber;

FIG. 3D is a front perspective view of the surface cleaning apparatus of FIG. 3B, with the on board energy storage member pack abutting a separation chamber as shown schematically in FIG. 3C;

FIG. 3E is a schematic view of the surface cleaning apparatus of FIG. 3A, with the on board energy storage member pack abutting a duct between the separation chamber and a filtration chamber;

FIG. 3F is a schematic view of the surface cleaning apparatus of FIG. 3A, with the on board energy storage member pack abutting a filtration chamber;

FIG. 3G is a front perspective view of the surface cleaning apparatus of FIG. 3B, with the on board energy storage member pack abutting a filtration chamber as shown schematically in FIG. 3F;

FIG. 3H is a schematic view of the surface cleaning apparatus of FIG. 3A, with the on board energy storage member pack abutting a duct between the filtration chamber and a suction motor chamber;

FIG. 4 is a schematic view of a thermal transfer member;

FIG. 5A is a rear perspective view of an upright surface cleaning apparatus, with an on board energy storage member pack seated around a wand;

FIG. 5B is a front perspective view of an alternate upright surface cleaning apparatus, with an on board energy storage member pack abutting a wand;

FIG. 5C is a front perspective view of the surface cleaning apparatus of FIG. 5B, with the wand released from an upright section;

FIG. 5D is a front perspective view of the surface cleaning apparatus of FIG. 5B, with an alternate on board energy storage member pack seated around the wand;

FIG. 5E is a front perspective view of the surface cleaning apparatus of FIG. 5B, with an on board energy storage member pack seated around the wand;

FIG. 6A is a right side elevation view of an alternate surface cleaning apparatus, according to an embodiment, in a storage position, with an on board energy storage member pack seated around an up flow duct; and,

FIG. 6B is a right side elevation view of the surface cleaning apparatus of FIG. 6A, in a reclined in use position.

### DESCRIPTION OF VARIOUS EMBODIMENTS

Numerous embodiments are described in this application, and are presented for illustrative purposes only. The described embodiments are not intended to be limiting in any sense. The invention is widely applicable to numerous embodiments, as is readily apparent from the disclosure herein. Those skilled in the art will recognize that the present invention may be practiced with modification and alteration without departing from the teachings disclosed herein. Although particular features of the present invention may be described with reference to one or more particular embodiments or figures, it should be understood that such features are not limited to usage in the one or more particular embodiments or figures with reference to which they are described.

The terms “an embodiment,” “embodiment,” “embodiments,” “the embodiment,” “the embodiments,” “one or more embodiments,” “some embodiments,” and “one embodiment” mean “one or more (but not all) embodiments of the present invention(s),” unless expressly specified otherwise.

The terms “including,” “comprising” and variations thereof mean “including but not limited to,” unless expressly specified otherwise. A listing of items does not imply that any or all of the items are mutually exclusive, unless expressly specified otherwise. The terms “a,” “an” and “the” mean “one or more,” unless expressly specified otherwise.

As used herein and in the claims, two or more parts are said to be “coupled”, “connected”, “attached”, “joined”, “affixed”, or “fastened” where the parts are joined or operate together either directly or indirectly (i.e., through one or more intermediate parts), so long as a link occurs. As used herein and in the claims, two or more parts are said to be “directly coupled”, “directly connected”, “directly attached”, “directly joined”, “directly affixed”, or “directly fastened” where the parts are connected in physical contact with each other. As used herein, two or more parts are said to be “rigidly coupled”, “rigidly connected”, “rigidly attached”, “rigidly joined”, “rigidly affixed”, or “rigidly fastened” where the parts are coupled so as to move as one while maintaining a constant orientation relative to each other. None of the terms “coupled”, “connected”, “attached”, “joined”, “affixed”, and “fastened” distinguish the manner in which two or more parts are joined together.

Further, although method steps may be described (in the disclosure and/or in the claims) in a sequential order, such methods may be configured to work in alternate orders. In other words, any sequence or order of steps that may be described does not necessarily indicate a requirement that the steps be performed in that order. The steps of methods described herein may be performed in any order that is practical. Further, some steps may be performed simultaneously.

Some elements herein may be identified by a part number, which is composed of a base number followed by an alphabetical or subscript-numerical suffix (e.g. 112a, or 112₁). Multiple elements herein may be identified by part numbers that share a base number in common and that differ by their suffixes (e.g. 112₁, 112₂, and 112₃). All elements with a common base number may be referred to collectively or generically using the base number without a suffix (e.g. 112).

For simplicity and clarity of illustration, where considered appropriate, reference numerals may be repeated among the figures to indicate corresponding or analogous elements or steps. In addition, numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments generally described herein.

A surface cleaning apparatus has one or more on board energy storage devices. The energy storage device may be, for example, a battery or a capacitor, such as a super capacitor.

An energy storage member may include one or more energy storage devices. Where more than one energy storage device is included in an energy storage member, the plurality of energy storage devices may be of a common size of or diverse sizes, shapes, and types. For example, an energy storage member may comprise a small flat battery and a large arcuate super capacitor. The energy storage devices may be provided in a housing and may be referred to as an energy storage member pack. For example, if the energy storage devices are batteries, then the energy storage member pack may be referred to as a battery pack.

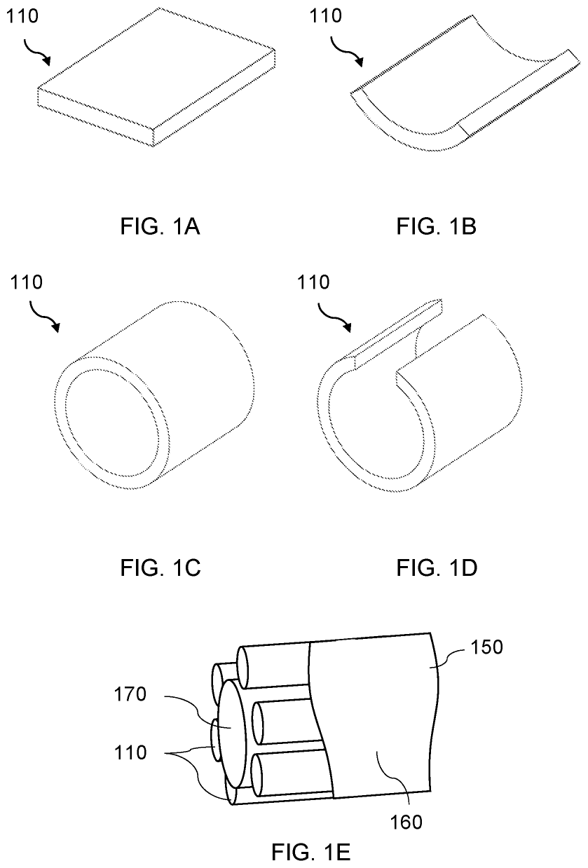

FIGS. 1A to 1D depict various possible shapes or configurations for a single energy storage device, or an energy storage member pack. Referring to FIG. 1A, energy storage device 110 is a flat, rigid device, however an energy storage device may also take on other shapes and rigidities. For example, energy storage device may be arcuate in shape (FIG. 1B) annular in shape (FIG. 1C) or partially annular in shape (FIG. 1D). It will be appreciated that an energy storage member pack may have any such shape.

FIG. 1E exemplifies an annular energy storage member pack 150 (i.e., the configuration of FIG. 1C) that surrounds a portion of an air flow passage 170 through a surface cleaning apparatus. As exemplified, energy storage member pack 150 contains a set of six energy storage devices 110 (e.g., cylindrical batteries) contained in a cover or outer housing 160. As exemplified, energy storage devices 110 are each cylindrical batteries having a common size.

It will be appreciated that the energy storage members may be mounted in a closed housing that surrounds and supports the energy storage members, as is known in the art. Accordingly, the battery pack 150 shown in FIG. 1E may have an inner housing (not shown) and front and rear end faces that enclose the batteries.

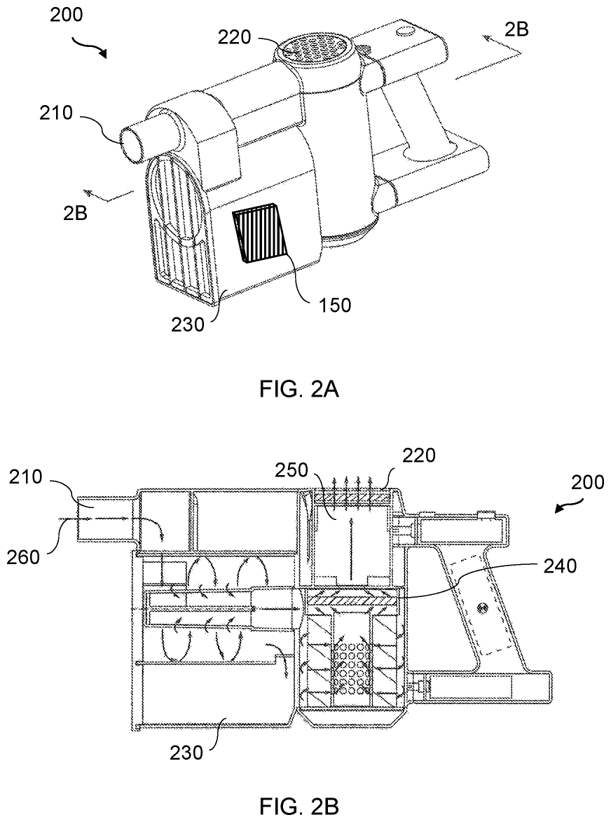

In accordance with one aspect of this disclosure, an energy storage device and/or an energy storage member pack 150 is positioned in direct thermal communication with an air flow path through a surface cleaning apparatus at a location on the air flow path that is upstream of the suction motor (e.g., it may abut or surround or form part of part of the air flow path). As exemplified in FIGS. 2A, 3A-3G, 5A-5E, and 6A-6B, pack 150 may be provided in thermal communication at various different locations of the air flow path.

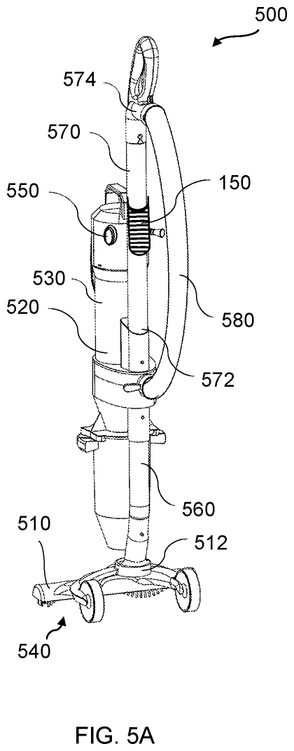

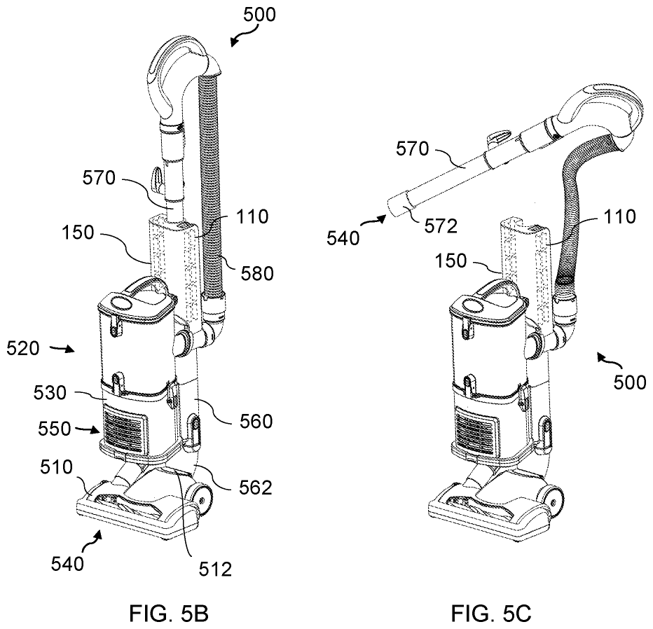

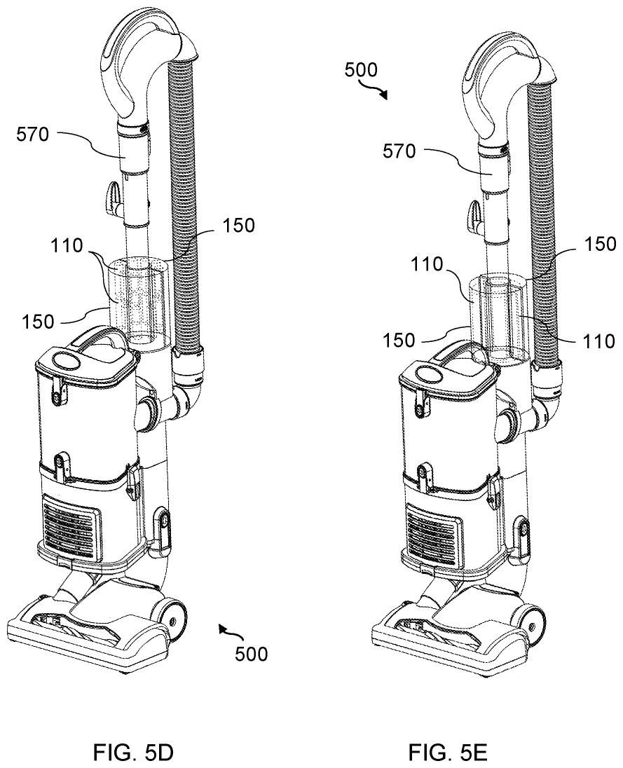

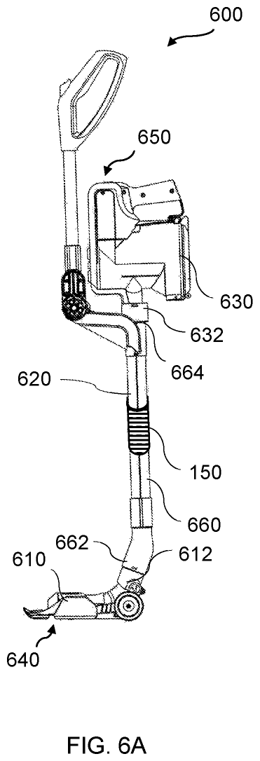

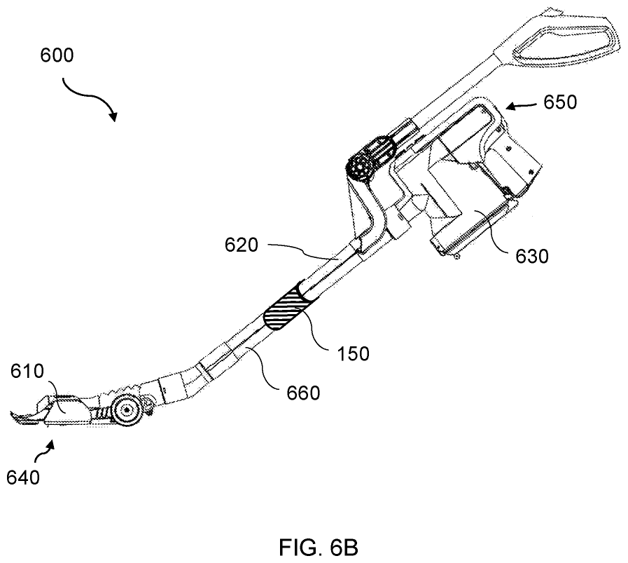

As exemplified in FIGS. 2A and 2B, the energy storage member pack 150 is used for powering a suction motor 250 of a hand vacuum cleaner 200. Hand vacuum cleaner 200 is a vacuum cleaner that can be operated generally by a single hand to clean a surface while the weight of the hand vacuum cleaner is held by the same hand. However, it will be appreciated that the energy storage member may be used to power alternate types of surface cleaning apparatus. Other examples of surface cleaning apparatus include upright vacuum cleaners (see for example FIGS. 5A-5E), canister type vacuum cleaners, stick vacuum cleaners (see for example FIGS. 6A and 6B), wet-dry type vacuum cleaners, and carpet extractors.

Surface cleaning apparatus 200 includes an air flow passage extending from a dirty air inlet 210 to a clean air outlet 220. An air treatment member 230 and a suction motor 250 are provided in the air flow path. As exemplified, air treatment member 230 includes a cyclonic cleaning stage, commonly known as a ‘cyclone’, and is provided upstream of suction motor 250 to remove dirt particles and other debris from the air flow. Surface cleaning apparatus 200 may use any air treatment member.

On board energy storage member pack 150 is operatively connected to the suction motor 250. However, while pack 150 is operatively coupled to suction motor 250 to power the suction motor 250, it need not be not adjacent to suction motor 250. Rather, on board energy storage member pack 150 is in thermal conductive communication with a portion of the air flow passage upstream of suction motor 250.

Accordingly, on board energy storage member pack 150 may abut and may be secured to or form part of an exterior surface of a wall of the air flow passage upstream of suction motor 250.

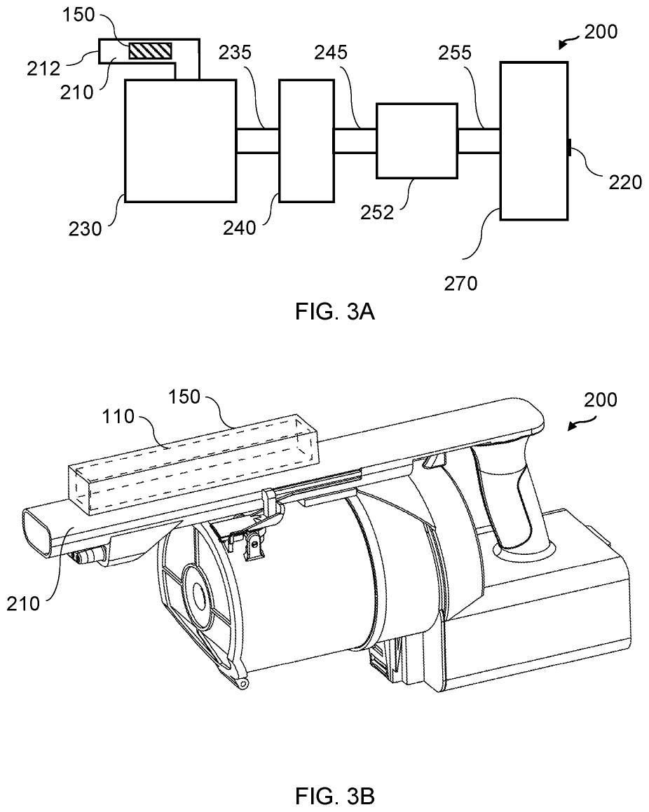

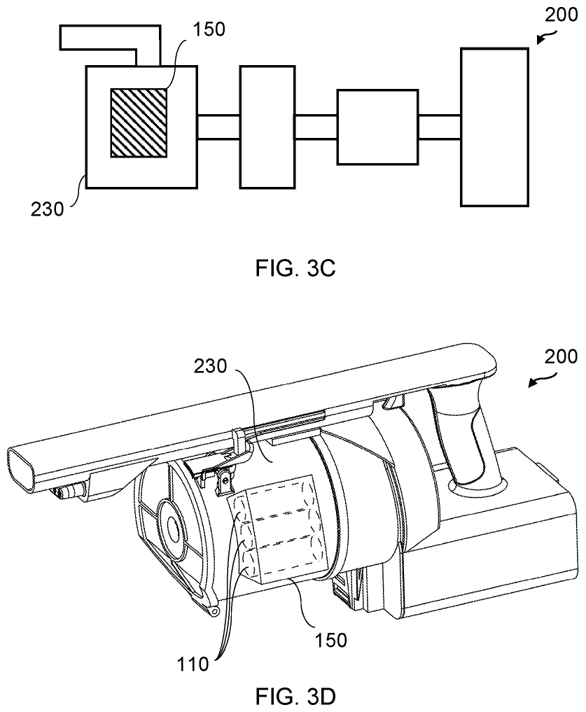

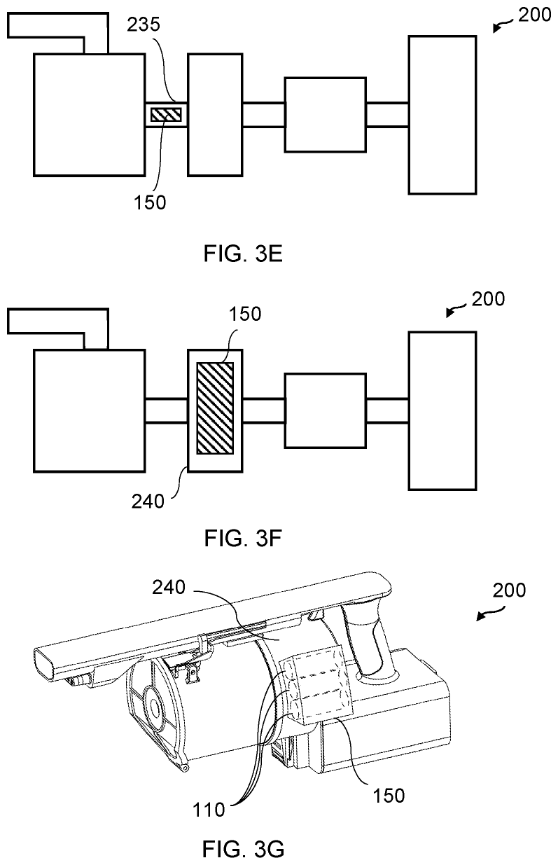

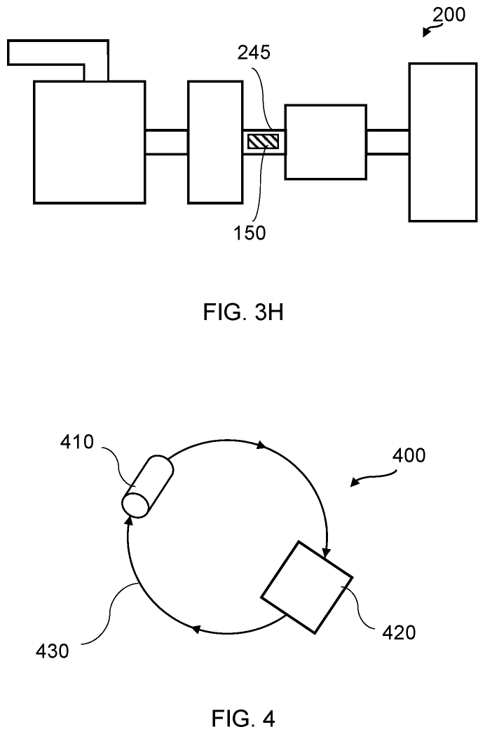

As exemplified in FIG. 1E, the pack 150 may surround an air flow conduit 170 and, as such, an inner pack housing may not be provided. Alternately, pack 150 may have an inner housing that defines the air flow path 170, which may be any duct or conduit in the surface cleaning apparatus, such as inlet conduit 210 or any of ducts 235, 245 and 255 shown in FIG. 3A.

As exemplified in FIG. 2A, on board energy storage member pack 150 is secured to an exterior surface of a wall of air treatment member 230. As air travels (e.g., cyclones) within the air treatment member 230, relatively cool air passes over a wall in thermal communication with the pack 150 and assists in cooling the pack 150. As on board energy storage member pack 150 is provided on an exterior surface of the wall structure of the air flow passage, this reduces buildup of dirt and debris on the on board energy storage member pack 150 as dirty air flows through the air flow passage.

The wall of the air treatment member 230 may be made of a thermally conductive material, such as a metal or thermally conductive plastic. Similarly, a housing of an energy storage member contained in pack 150 may be made of a thermally conductive material. Accordingly, heat generated by the energy storage member contained in the pack 150 can be transferred to and through the wall of air treatment member 230 to be transferred to the air flow 260 through the air flow passage.

Pack 150 exemplified in FIG. 2A may contain a single energy storage device. In other embodiments, a plurality of energy storage devices may be contained in pack 150. Alternately, or in addition, a plurality of packs 150 may be provided and may be in thermal communication with the air flow path at two or more locations upstream of the suction motor 250 and operatively coupled to suction motor 250 to provided energy to suction motor 250.

FIGS. 3A to 3E exemplify a number of possible locations at which a pack 150 may be provided so as to be in thermal conductive communication with the air flow path 260 at a location upstream of the suction motor 250.

As depicted in FIG. 3A, air enters surface cleaning apparatus 200 via dirty air inlet 212 at the upstream end of inlet passage 210. Air then travels through the separator chamber 230, then through a duct 235 to an optional pre-motor filter chamber 240. The pre-motor filter chamber 240 may contain any type of pre-motor filter known in the art, such as a porous filter media (e.g., foam, felt). Subsequently, the air passes through a duct 245 from the filter chamber 240 for passing the air flow to a suction motor chamber 252, containing a suction motor 250. The air flow passage of surface cleaning apparatus 200 also includes a duct 255 from the suction motor chamber 252 for passing the air flow to an optional post motor filter chamber 270, and then to a clean air outlet 220 from the post motor filter chamber 270. The post motor filter media may be any type of post motor filter known in the art, such as a High Efficiency Particulate Air (HEPA) filter.

As exemplified in FIGS. 3A and 3B, pack 150, containing energy storage device 110, may abut inlet passage 210. FIGS. 3C and 3D exemplify the pack 150, containing energy storage devices 110, abutting separator chamber (e.g., a cyclone chamber) 230. FIG. 3E exemplifies the pack 150 abutting duct 235. FIGS. 3F and 3G exemplify the pack 150, containing energy storage devices 110, abutting filter chamber 240. FIG. 3H exemplifies the pack 150 abutting duct 245. In some embodiments, an on board energy storage member or pack containing at least one on board energy storage member may abut more than one duct or chamber of a surface cleaning apparatus.

As exemplified, an on board energy storage member or pack containing at least one on board energy storage member abuts a wall of an air flow passage. In some embodiments, it may be received in a recess or cavity of an air flow passage wall. However, in some embodiments a wall of an on board energy storage member, or a wall of a pack containing at least one on board energy storage member, may form a wall or part of a wall defining the air flow passage as discussed with respect to FIG. 1E.

It will be appreciated that the shape or configuration of the energy storage member or pack 150 may be selected to conform with the shape of the portion of the wall of the air flow path that it abuts or forms part of. Accordingly, the energy storage member or pack may be of any shape and may be any of those set of in FIGS. 1A-1D. For example, in some embodiments, an on board energy storage member or pack containing at least one on board energy storage member may be substantially planar and may be secured to a substantially planar wall of an air flow passage. However, where a wall of an air flow passage is non-planar, such as an cylindrical duct, an on board energy storage member or pack containing at least one on board energy storage member may be annular or substantially annular in configuration.

While FIGS. 3A to 3E exemplify a single pack 150, it will be appreciated that, in some embodiments, a plurality of on board energy storage members or a plurality of packs 150, each containing at least one on board energy storage member, may be positioned at different locations upstream of suction motor 250. For example, a first pack 150 may be secured to a first sidewall of a chamber or duct and a second pack secured to an opposite side wall of the same chamber or duct or to a sidewall of another chamber or duct.

In accordance with a second aspect, an on board energy storage member, or a pack containing at least one on board energy storage member, may be in thermal communication with the air flow passage via a thermal transfer member, such as a heat pipe, or simply a length of conductive material (e.g., copper wire or conductive tape). An advantage of this aspect is that the energy storage member(s) may be located at a position that may assist in the ergonomics of the hand vacuum cleaner yet still be cooled by the air flow path upstream of the suction motor 250.

In accordance with this aspect, as exemplified in FIG. 4, a heat pipe 400 may be used, in which case the heat dissipating portion 420 of the heat pipe may be in thermal communication (e.g., abut or surround or form part of) the air flow path at various different locations of the air flow path upstream of the suction motor 250, as exemplified in FIGS. 2A, 3A-3E, 5 and 6A-6B.

As exemplified in FIG. 4, thermal transfer member 400 comprises a heat absorbing portion (e.g. a payload heat exchanger) 410, which is conductively coupled to the energy storage member or pack 150, a heat dissipating portion (e.g. a radiator heat exchanger) 420, which is in thermal communication with the air flow path, and a heat transfer structure 430. For example, in the case of a heat pipe, the heat dissipating portion 420 may be a condenser thermally coupled to a heat sink (e.g., a wall of the air flow path) to dissipate heat into air flowing through an air flow passage and the heat absorbing portion 410 may be the payload heat exchanger (e.g., an evaporator) thermally coupled to the energy storage member or pack 150. The transfer structure 430 may be a wick for transferring liquid by capillary action and a space for vapor movement between the condenser and the evaporator as is known in heat pipes. The heat-absorbing portion 410 may abut or surround the energy storage member of pack 150 and the heat-dissipating portion 420 may abut, surround, or form part of a wall of the air flow path.

In another example, the thermal transfer member may use a fluid loop without phase change. In such a case, a circulating pump may be also included to circulate the fluid through the transfer structure 430.

A thermal transfer member such as member 400 can allow an on board energy storage member, or pack containing at least one on board energy storage member, to be placed away from the air flow passage while being in thermal communication with the air flow passage. A thermal transfer member such as member 400 can also allow an on board energy storage member, or pack containing at least one on board energy storage member, to be placed adjacent or surrounding or as part of a first portion of an air flow passage while also dissipating heat into a second portion of the air flow passage by way of a radiator heat exchanger.

FIG. 5A exemplifies an upright vacuum cleaner. FIGS. 5B to 5E depict an alternate embodiment of an upright vacuum cleaner. Surface cleaning apparatus 500 is a reconfigurable upright vacuum cleaner. Surface cleaning apparatus 500 includes a surface cleaning head 510 and an upright section 520. Upright section 520 includes a suction and filtration unit 530, which may be removably mounted to the up flow duct.

As exemplified, a dirty fluid inlet 540 is provided in surface cleaning head 510. A fluid flow passage extends from the dirty fluid inlet 540 to a clean fluid outlet 550. Clean fluid outlet 550 is provided in upright section 520. In alternate embodiments, clean fluid outlet 550 may be provided elsewhere, such as on surface cleaning head 520.

As exemplified, upright section 520 is pivotally mounted with respect to surface cleaning head. In the exemplified embodiment shown, air enters dirty fluid inlet 540 in surface cleaning head 510, and is directed to an up flow duct 560. Up flow duct 560 is pivotally mounted to surface cleaning head 510 at an upstream end 562 by a pivoting connector 512. Up flow duct 560 may be made of metal and may function as a support on which upright section 520 is supported.

As exemplified, upright section 520 of surface cleaning apparatus 500 includes a handle or wand extension 570 in fluid communication with up flow duct 560. The air flow passage of apparatus 500 includes up flow duct 560, a first passage in upright section 520 between up flow duct 560 and first end 572 of wand 570, wand 570, flexible conduit 580 extending from a second end 574 of wand 570 to a second passage in upright section 520 distinct from the first passage, and into suction and filtration unit 530. Suction and filtration unit 530 includes an air treatment member and a suction motor, and the fluid flow path extends through the air treatment member and suction motor and out through clean air outlet 550.

As exemplified, wand extension 570 is an above-floor cleaning wand. Wand 570 is releasable from upright section 520, and is secured to upright section 520 at inlet end 572 by a releasable mounting system. To reconfigure the surface cleaning apparatus to an above-floor configuration, wand 570 is released from upright section 520 at first end 572, and first end 572 becomes an alternate, above floor cleaning dirty fluid inlet 540. Upright section 520 may also be releasable, and may be connected to up flow duct 560 by a releasable mounting system. A user may release upright section 520 from up flow duct 560 and carry upright section 520, such as during above-floor cleaning. Any releasable mounting systems may be used, which each may include a releasable locking mechanism such as a latch or a friction or snap fit.

The suction motor of upright section 520 is operably connected to an on board energy storage member pack 150 to receive energy therefrom. On board energy storage member pack 150 may be of any type discussed herein. In some embodiments, an on board energy storage member, or a pack containing at least one on board energy storage member, is seated against or around or forms part or all of a wall defining an air flow passage.

In some embodiments, an on board energy storage member, or a pack containing at least one on board energy storage member, is seated in a wall defining an air flow passage rather than seated around the wall, such as by being seated in a recess or set of recesses of an exterior or interior surface of the wall. Alternately, it may form part of the air flow path. For example, in some embodiments, on board energy storage member pack 150 may be seated around wand 570 and secured, such as by adhesive or mechanical fasteners, to wand 570 or to a portion of apparatus 500 in a position such that it abuts wand 570 when wand 570 is secured to upright section 520.

Examples of on board energy storage member pack configurations that may be used are depicted in FIGS. 5A to 5E. As depicted in FIG. 5A, on board energy storage member pack 150 may be an energy storage member pack comprising a plurality of batteries arranged in an annular configuration that seats around a portion of wand 570. As depicted in FIGS. 5B and 5C, on board energy storage member pack 150 may contain a plurality of batteries 110 and may be a generally U-shaped member that is secured to upright section 520 and which has a recess that receives a portion of wand 570 when wand 570 is secured to upright section 520. As depicted in FIGS. 5D and 5E, apparatus 500 may include a pair of on board energy storage member packs 150 which each contain a plurality of energy storage devices 110 (e.g. the configuration of FIG. 5D) or a single energy storage device 110 (e.g. the configuration of FIG. 5E), and which together are arranged in an annular configuration that seats around a portion of wand 570.

FIGS. 6A and 6B exemplify another surface cleaning apparatus 600. Surface cleaning apparatus 600 is a reconfigurable stick vac type vacuum cleaner and, as exemplified, includes a surface cleaning head 610, an upper section 620, and a suction and treatment member 630. An airflow path through apparatus 600 extends from dirty fluid inlet 640 in surface cleaning head 610, downstream through up flow duct 660 of upper section 620 and then through suction and treatment member 630 to clean air outlet 650. Up flow duct 660 has an upstream end 662 drivingly connected to a pivot joint 612 of surface cleaning head 610, and a downstream end 664 connected to an inlet nozzle 632 of suction and treatment member 630.

Suction and treatment member 630 includes an air treatment member and a suction motor positioned in the airflow path between inlet nozzle 632 and clean air outlet 650.

Surface cleaning apparatus 600 is movable between an storage position shown in FIG. 6A in which suction and treatment member 630 is substantially vertically aligned above surface cleaning head 610 and up flow duct 660 is substantially vertically oriented, and a reclined in use position shown in FIG. 6B in which suction and treatment member 630 is positioned behind surface cleaning head 610 and up flow duct 660 extends at an angle to vertical.

Surface cleaning apparatus 600 further includes an on board energy storage member pack 150. On board energy storage member pack 150 is provided to store energy, such as energy used to power a suction motor of suction and treatment member 630. On board energy storage member pack 150 is arranged in an annular configuration seated around up flow duct 660. On board energy storage member pack 150 may be of any type discussed herein, such as a plurality of batteries arranged in an annular arrangement seated around a portion of wand up flow duct 660.

While the above description provides examples of the embodiments, it will be appreciated that some features and/or functions of the described embodiments are susceptible to modification without departing from the spirit and principles of operation of the described embodiments. Accordingly, what has been described above has been intended to be illustrative of the invention and non-limiting and it will be understood by persons skilled in the art that other variants and modifications may be made without departing from the scope of the invention as defined in the claims appended hereto. The scope of the claims should not be limited by the preferred embodiments and examples, but should be given the broadest interpretation consistent with the description as a whole.

I claim:

1. A surface cleaning apparatus having an on board energy storage member, the surface cleaning apparatus comprising:
(a) an air flow passage from a dirty air inlet to a clean air outlet with an air treatment member and a suction motor provided in the air flow path; and,
(b) at least one energy storage member operably connected to the suction motor, wherein the at least one energy storage member, or an energy storage member pack containing the at least one energy storage member, is in thermal conductive communication with the air flow passage at a location upstream of the suction motor.

2. The surface cleaning apparatus of claim 1 wherein the at least one energy storage member, or the energy storage member pack containing the at least one energy storage member, abuts a portion of the air flow passage.

3. The surface cleaning apparatus of claim 1 wherein the at least one energy storage member, or the energy storage member pack containing the at least one energy storage member, is in thermal conductive communication with the air treatment member.

4. The surface cleaning apparatus of claim 3 wherein the air treatment member with which the at least one energy storage member, or the energy storage member pack containing the at least one energy storage member, is in thermal conductive communication is a cyclone.

5. The surface cleaning apparatus of claim 3 wherein the air treatment member with which the at least one energy storage member, or the energy storage member pack containing the at least one energy storage member, is in thermal conductive communication is a pre-motor filter chamber.

6. The surface cleaning apparatus of claim 1 wherein the at least one energy storage member, or the energy storage member pack containing the at least one energy storage member, is in thermal conductive communication with an above floor cleaning wand.

7. The surface cleaning apparatus of claim 1 wherein the at least one energy storage member comprises a plurality of batteries that are arranged around an open interior volume and a portion of the air flow passage extends through the open interior.

8. The surface cleaning apparatus of claim 7 further comprising a surface cleaning head and an upper section moveably mounted to the surface cleaning head between a storage position and a reclined in use position, the upper section comprising an up flow duct, wherein the at least one energy storage member, or the energy storage member pack containing the at least one energy storage member, is in thermal conductive communication with the up flow duct.

9. The surface cleaning apparatus of claim 7 wherein the plurality of batteries are arranged in an annular configuration that seats around a portion of the air flow passage.

10. The surface cleaning apparatus of claim 1 wherein the surface cleaning apparatus comprises a hand vacuum cleaner having an inlet passage and the at least one energy storage member, or the energy storage member pack containing the at least one energy storage member, is in thermal conductive communication with the inlet passage.

11. A surface cleaning apparatus having an on board energy storage member, the surface cleaning apparatus comprising:
(a) an air flow passage from a dirty air inlet to a clean air outlet with an air treatment member and a suction motor provided in the air flow path;
(b) at least one energy storage member operably connected to the suction motor; and,
(c) a heat pipe thermally connecting the at least one energy storage member, or an energy storage member pack containing the at least one energy storage member, with the air flow passage at a location upstream of the suction motor.

12. The surface cleaning apparatus of claim 11 wherein the heat pipe is in thermal conductive communication with the air treatment member.

13. The surface cleaning apparatus of claim 12 wherein the air treatment member with which the heat pipe is in thermal conductive communication is a cyclone.

14. The surface cleaning apparatus of claim 12 wherein the air treatment member with which the heat pipe is in thermal conductive communication is a pre-motor filter chamber.

15. The surface cleaning apparatus of claim 11 wherein the heat pipe is in thermal conductive communication with an above floor cleaning wand.

16. The surface cleaning apparatus of claim 11 wherein the surface cleaning apparatus comprises a hand vacuum cleaner having an inlet passage and the heat pipe is in thermal conductive communication with the inlet passage.
